(19) United States
(12) Patent Application Publication
(10) Pub. No.: US 2025/0293265 A1
(43) Pub. Date: Sep. 18, 2025

(54) BIPOLAR PLATE FOR METAL-AIR/LIQUID BATTERIES

(71) Applicant: RTX CORPORATION, Arlington, VA (US)

(72) Inventors: James Saraidaridis, East Hartford, CT (US); Robert Darling, East Hartford, CT (US); Andrzej Kuczek, East Hartford, CT (US)

(21) Appl. No.: 18/607,896

(22) Filed: Mar. 18, 2024

(51) Int. Cl. H01M 4/86; H01M 4/88; H01M 8/04007; H01M 8/04228; H01M 12/08

(52) U.S. Cl. CPC H01M 4/8631; H01M 4/8621; H01M 4/8875; H01M 8/04007; H01M 8/04228; H01M 12/08; H01M 2004/8694

(57) ABSTRACT

A bipolar plate for a battery includes a metal sheet that has a first side and a second, opposite side. The metal sheet is folded so as to form a series of loops on the second side. The loops are spaced apart to define flow field passages therebetween on the second side. Each of the loops is bonded along an edge at the first side so as to enclose an internal passage.

### BACKGROUND

A metal-air battery system is an energy storage system based on electrochemical charge/discharge reactions that occur between a positive “air electrode” (the cathode during discharge) and a negative “metal electrode” the (anode during discharge). The negative electrode is typically made of metals such as Li, Zn, Al, Fe, or Na, while the positive electrode usually contains some form of porous carbon material and a catalyst. There is an electrolyte between the electrode that serves as an ionic charge carrier. The electrolyte can be any combination of aqueous or non-aqueous solutions, and solid or liquid ionic conducting media.

During discharge, oxygen from the atmospheric air or an oxygen storage tank diffuses through the porous carbon positive electrode, where the catalyst facilitates its reduction, while the metal is oxidized in the anodic reaction. As much of the cell volume is occupied by the anode material, metal-air batteries typically have high energy densities in comparison to other types of batteries. A metal-liquid battery is similar to a metal-air battery, except that a liquid reactant, which may be an oxygen mediator, is used instead of air.

### SUMMARY

A bipolar plate for a battery according to an example of the present disclosure includes a metal sheet that has a first side and a second side opposite the first side. The metal sheet is folded so as to form a series of loops on the second side. The loops are spaced apart to define flow field passages therebetween on the second side. Each of the loops is bonded along an edge at the first side so as to enclose an internal passage.

In a further embodiment of any of the foregoing embodiments, the first side is substantially flat.

In a further embodiment of any of the foregoing embodiments, an arrangement of the flow field passages is selected from the group consisting of a parallel flow field and an interdigitated flow field.

In a further embodiment of any of the foregoing embodiments, the metal sheet is selected from the group consisting of stainless steel, copper, aluminum, titanium, and tin.

In a further embodiment of any of the foregoing embodiments, the first side includes a conductive and/or protective coating.

In a further embodiment of any of the foregoing embodiments, the metal sheet is multi-layered.

A further embodiment of any of the foregoing embodiments includes a thermal working material in the internal passages.

In a further embodiment of any of the foregoing embodiments, the thermal working material is selected from the group consisting of a wax, a fire retardant, and a refrigerant.

A further embodiment of any of the foregoing embodiments includes a porous wick in the internal passages.

In a further embodiment of any of the foregoing embodiments, each of the loops has a triangular cross-section.

A battery according to an example of the present disclosure includes at least one cell that has a metal anode, a cathode, and an electrolyte between the metal anode and the cathode. The cathode includes a bipolar plate that has a metal sheet that defines a negative first side and a positive second side opposite the negative first side. The metal sheet is folded so as to form a series of loops on the positive second side. The loops are spaced apart to define flow field passages therebetween on the positive second side. Each of the loops are bonded along an edge at the negative first side so as to enclose an internal passage.

In a further embodiment of any of the foregoing embodiments, the negative first side is substantially flat.

In a further embodiment of any of the foregoing embodiments, an arrangement of the flow field passages is selected from the group consisting of a parallel flow field and an interdigitated flow field.

In a further embodiment of any of the foregoing embodiments, the positive second side is coated with a catalyst metal and the negative first side is coated with a material that alters surface energy to promote better plating morphology.

In a further embodiment of any of the foregoing embodiments, the metal sheet is multi-layered.

A further embodiment of any of the foregoing embodiments includes a thermal working material in the internal passages.

A further embodiment of any of the foregoing embodiments includes a porous wick in the internal passages.

In a further embodiment of any of the foregoing embodiments, the cathode is configured as an air cathode.

A method for fabricating a bipolar plate for a battery according to an example of the present disclosure includes providing a substantially flat metal sheet that has a first side and a second side opposite the first side, and bending the metal sheet to form a series of loops on the second side. The loops are spaced apart to define flow field passages therebetween on the second side, and then bonding each of the loops along an edge at the first side so as to enclose an internal passage.

In a further embodiment of any of the foregoing embodiments, the bending includes roll-forming, metal protrusion, or stamping.

The present disclosure may include any one or more of the individual features disclosed above and/or below alone or in any combination thereof.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example battery.

FIG. 2 illustrates an example cathode of the battery.

FIG. 3 illustrates a bipolar plate of the cathode.

FIG. 4 illustrates a parallel flow field.

FIG. 5 illustrates an interdigitated flow field.

FIG. 6 illustrates an example in which there is a thermal working fluid in the bipolar plate.

FIG. 7 illustrates an example in which there is a porous wick in the bipolar plate.

FIG. 8 illustrates a method of fabricating a bipolar plate.

FIG. 9 illustrates a multi-layered metal sheet of a bipolar plate.

### DETAILED DESCRIPTION

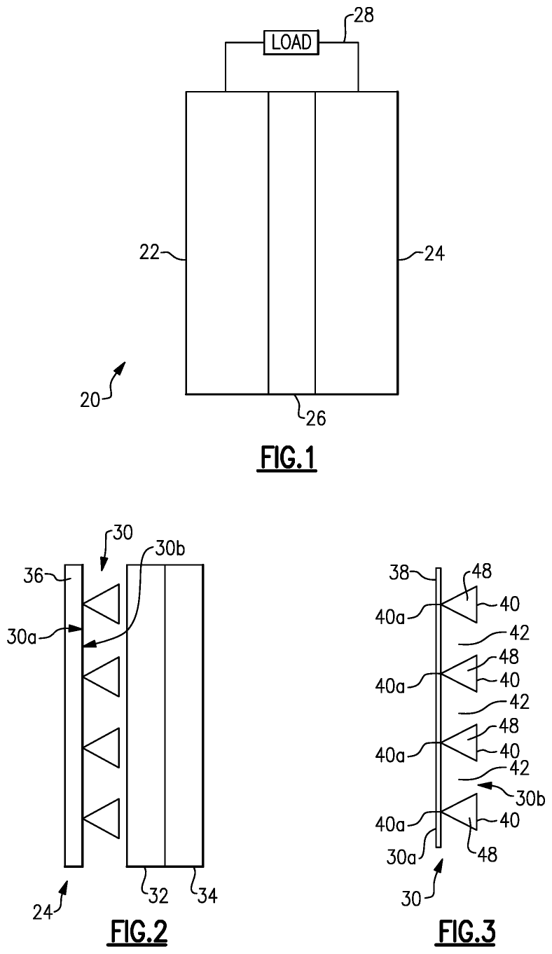

FIG. 1 schematically illustrates an example of a metal-air battery 20. As examples, the battery 20 may be used in an aircraft, a vehicle, or as a stationary battery, but are not limited to these end-uses. In general, the battery 20 includes one or more cells that include a metal anode 22, an air cathode 24 (the electrode and associated structure where oxygen is made available and reacts), and an electrolyte 26 between the anode 22 and the cathode 24. The metal anode 22 and the air cathode 24 are connected by an electric circuit 28. The electrolyte 26 may be a liquid electrolyte, such as an aqueous solution, or a solid electrolyte. It is to be appreciated that although the battery 20 is described with the air cathode 24, the example is also applicable to a metal-liquid battery.

FIG. 2 illustrates an example of the air cathode 24. The air cathode includes a bipolar plate 30. The bipolar plate 30 has a first side 30a and an opposite, second side 30b. Adjacent the second side 30b there is a gas diffusion layer 32 and a catalyst layer 34, although these functions can alternatively be combined into a single layer. In this example, the bipolar plate 30 also includes a conductive and/or protective coating 36, such as a nickel coating, on the first side 30a to protect the bipolar plate 30. Alternatively or additionally, a titanium dioxide coating may be provided by atomic layer deposition. The titanium dioxide acts as a nucleation layer to facilitate lithium plating morphology. A LixTiO2 complex forms during lithium plating and the lithiophilic titanium dioxide surface layer enables uniform and reversible Li plating.

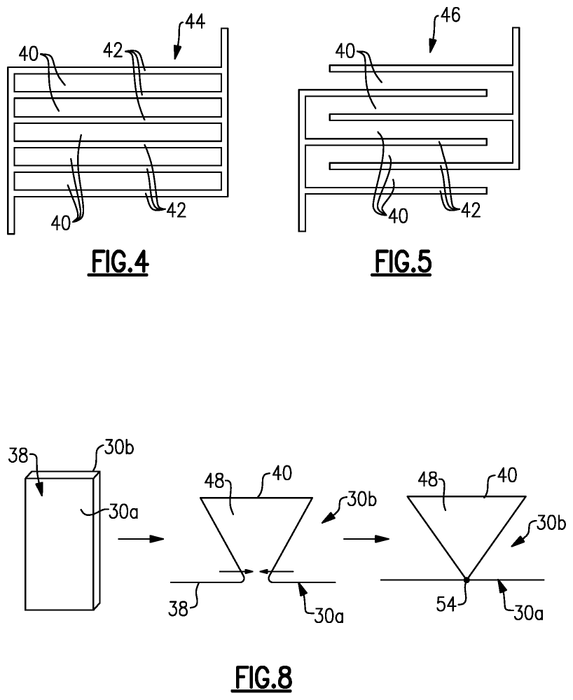

The bipolar plate 30 is also shown in an isolated view in FIG. 3. The bipolar plate 30 is a single-piece component that is formed from a metal sheet 38. The “metal” of the metal sheet 38 is a pure metal or a metal alloy. For example, the metal sheet 38 may be stainless steel, copper or copper alloy, aluminum or aluminum alloy, titanium or titanium alloy, or tin. The metal sheet 38 is folded so as to form a series of ribs or loops 40 on the second side 30b. As used herein, a “series” refers to a group of three or more loops 40 that are uniformly spaced apart, are of substantially the same cross-sectional shape, and are of common orientation on the metal sheet 38. In the illustrated example, the loops 40 are each triangular in cross-section but alternatively could be a different polygonal shape, round, or teardrop. The loops 40 are spaced apart to define flow field passages 42 therebetween on the second side 30b. There are no flow field passages 42 on the first side, and the bipolar plate 30 thus has a single-sided flow field. The flow field passages 42 may be provided as a parallel flow field 44 as shown in an example in FIG. 4 or as an interdigitated flow field 46 as shown in FIG. 5 (“interdigitated” may also refer to a partially interdigitated flow field). Referring again to FIG. 3, each of the loops 40 is bonded along an edge 40a at the first side 30a so as to enclose an internal passage 48.

The internal passage 48 is fluidly isolated from the flow field passages 42 and, in a further example in FIG. 6, may include a thermal working material 50. The thermal working material 50 is used for thermal management in the battery 20. For instance, the thermal working material 50 is a wax that is initially solid and absorbs heat in the battery 20. Upon heating, the wax liquifies or vaporizes and may flow through the internal passage 48 to a heat sink where the heat is ejected, or remain stationary and reject heat to a heat sink. In this regard, the material 50 may be sealed in the passages 48 or circulated in a cooling circuit through the passages 48. In another example, the thermal working material 50 is or contains a fire retardant to facilitate suppression of a flame event in the battery 20. In another example, the thermal working material 50 is or contains a refrigerant, such as R134a, to facilitate heat transfer. The material 50 may also serve as a passive shutdown feature, where in the event of a breach of the loops 40, the material 50 flows into the flow field passages 42 to block flow of the air or liquid reactant or to “poison” the electrodes and reduce ionic or electric conductivity.

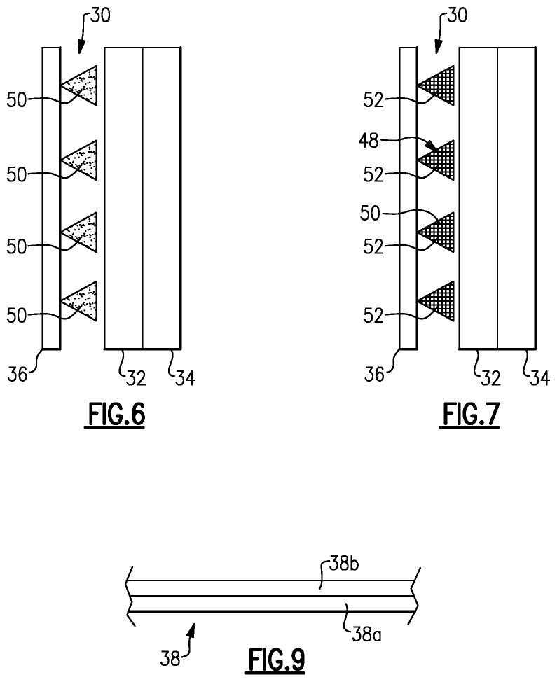

In another example in FIG. 7, the passages 48 include a porous wick 52. The thermal working material 50 is provided in the pores of the porous wick 52. The porous wick 52 may serve to facilitate heat transfer and/or transport of the material 50. For example, the porous wick 52 includes or is made from sintered particles, foam, mesh, fibers, wires, or a 3D printed lattice, having either isotropic and/or orthotropic thermal, hydraulic and mechanical properties, with good wetting properties to enhance the capillary force of the working fluid

FIG. 8 depicts an example method of fabricating the bipolar plate 30. Initially, the metal sheet 38 is provided in a substantially flat form. As an example, the metal sheet 38 is a foil that has a thickness of less than 200 micrometers, such as less than 100 micrometers or less than 70 micrometers. The metal sheet 38 is a single-layer in that it includes a single layer of metal. Alternatively, however, as shown in FIG. 9, the metal sheet 38 (and thus the bipolar plate 30) is multi-layered and includes at least first and second layers 38a/38b of different metallic compositions (e.g., an aluminum or aluminum alloy layer and a nickel or nickel alloy layer). The compositions of the layers 38a/38b may be selected to tailor the properties of the bipolar plate 30. For example, the compositions may be selected to tailor the surface energy of the bipolar plate 30, to tailor the chemical compatibility with reactants or electrode materials, and/or to tailor the mechanical properties of the bipolar plate 30.

Next, the metal sheet 38 is bent to form the loops 40 on the second side 30b. For example, after the bending, the loops 40 are open along one edge and do not fully enclose the internal passages 48. In one example, the bending is conducted in a roll-forming operation in which the sheet 38 is moved over a succession of rollers that progressively decrease in radius such that the sheet 38 is incrementally bent, roller-by-roller, until achieving the final desired bend shape. In another example, the bending is conducted in a stamping operation in which the sheet 38 is moved through a succession of stamping dies that progressively decrease in radius such that the sheet 38 is incrementally bent, die-by-die, until achieving the final desired bend shape. In another example, the bending is conducted in a metal pultrusion operation in which the sheet 38 is pulled over a succession of rollers that progressively decrease in radius such that the sheet 38 is incrementally bent, roller-by-roller until achieving the final desired bend shape.

Next, the sides of the loop 40 at the open edge are brought together and bonded along the edge at the first side 30a so as to enclose internal passages 42. For example, the sides are joined in a laser welding operation and form seams 54 along the first side 30a. As will be appreciated, other joining operations may be used, depending on the metal that the sheet 38 is made of. In this regard, once fabrication is completed, the first side 30a is substantially flat except for surface discontinuities at the seams 54, though the seams 54 may be smoothed over if greater flatness is desired.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A bipolar plate for a battery, comprising:
a metal sheet having a first side and a second side opposite the first side, the metal sheet being folded so as to form a series of loops on the second side, the loops being spaced apart to define flow field passages therebetween on the second side, each of the loops being bonded along an edge at the first side so as to enclose an internal passage.

2. The bipolar plate as recited in claim 1, wherein the first side is substantially flat.

3. The bipolar plate as recited in claim 1, wherein an arrangement of the flow field passages is selected from the group consisting of a parallel flow field and an interdigitated flow field.

4. The bipolar plate as recited in claim 1, wherein the metal sheet is selected from the group consisting of stainless steel, copper, aluminum, titanium, and tin.

5. The bipolar plate as recited in claim 1, wherein the first side includes a conductive and/or protective coating.

6. The bipolar plate as recited in claim 1, wherein the metal sheet is multi-layered.

7. The bipolar plate as recited in claim 1, further comprising a thermal working material in the internal passages.

8. The bipolar plate as recited in claim 7, wherein the thermal working material is selected from the group consisting of a wax, a fire retardant, and a refrigerant.

9. The bipolar plate as recited in claim 1, further comprising a porous wick in the internal passages.

10. The bipolar plate as recited in claim 1, wherein each of the loops has a triangular cross-section.

11. A battery comprising:
at least one cell including
a metal anode;
a cathode; and
an electrolyte between the metal anode and the cathode,
the cathode including a bipolar plate having a metal sheet defining a negative first side and a positive second side opposite the negative first side, the metal sheet being folded so as to form a series of loops on the positive second side, the loops being spaced apart to define flow field passages therebetween on the positive second side, each of the loops being bonded along an edge at the negative first side so as to enclose an internal passage.

12. The battery as recited in claim 11, wherein the negative first side is substantially flat.

13. The battery as recited in claim 11, wherein an arrangement of the flow field passages is selected from the group consisting of a parallel flow field and an interdigitated flow field.

14. The battery as recited in claim 11, wherein the positive second side is coated with a catalyst metal and the negative first side is coated with a material that alters surface energy to promote better plating morphology.

15. The battery as recited in claim 11, wherein the metal sheet is multi-layered.

16. The battery as recited in claim 11, further comprising a thermal working material in the internal passages.

17. The battery as recited in claim 11, further comprising a porous wick in the internal passages.

18. The battery as recited in claim 11, wherein the cathode is configured as an air cathode.

19. A method for fabricating a bipolar plate for a battery, comprising:
providing a substantially flat metal sheet that has a first side and a second side opposite the first side;
bending the metal sheet to form a series of loops on the second side, the loops being spaced apart to define flow field passages therebetween on the second side; and
bonding each of the loops along an edge at the first side so as to enclose an internal passage.

20. The method as recited in claim 18, wherein the bending includes roll-forming, metal protrusion, or stamping.
